(19) United States
(12) Patent Application Publication
(10) Pub. No.: US 2009/0210359 A1
(43) Pub. Date: Aug. 20, 2009

(54) MERCHANDISING

(75) Inventor: Barbara Chapman, Oxford (GB)

Correspondence Address: LEMPIA BRAIDWOOD LLC, 223 W. JACKSON BLVD., SUITE 620, CHICAGO, IL, 60606, US

(73) Assignee: Chapman Research Limited, Oxford (GB)

(21) Appl. No.: 12/294,088

(22) PCT Filed: Mar. 22, 2007
(86) PCT No.: PCT/GB2007/001022

§ 371 Date: Sep. 23, 2008

(30) Foreign Application Priority Data
Mar. 24, 2006 (GB) 0605920.8

(51) Int. Cl. G06Q 90/00; B65D 25/54

(52) U.S. Cl. 705/500; 220/662

(57) ABSTRACT

The invention relates an apparatus (20) for merchandising including a point of sale (29), a stock of at least one product for sale (36, 38, 40), and a display point (22, 24, 26) having at least one package (30, 32, 34), the package including a replica of the at least one product for sale, wherein the apparatus is arranged to enable the package to be exchanged for the at least one product.

The invention relates to merchandising and in particular to an apparatus for merchandising, a merchandising kit, a package for merchandising and to a shop having an apparatus for merchandising.

There are many known merchandising systems; some are point of sale systems whereby goods are displayed at a sales counter, and some are more remote systems whereby goods are displayed on display shelves to be taken to the sales counter by a customer.

It is known to provide a card in a merchandising display in which the card is displayed on a display shelf of a shop in place of goods for sale. Each card indicates a product or item that is for sale with a short description and/or a picture. To purchase the item the customer selects a card and takes it to a service point in the shop where it is exchanged for the item. The customer then takes the item to the checkout and pays for it. Alternatively the customer selects a card and takes it to the checkout to pay, and then takes the card to the service point where it is exchanged for the item. This technique for selling goods is widely used in hardware stores for products such as drill bits or hand tools.

It has been discovered that when such cards are used the level of sales tends to decline. The cards suffer from the problem that customers think that the product or particular item is out of stock. This situation does not improve even when the card has a large colour photograph of the item for sale. Furthermore, the additional step of taking the card to a service point to be exchanged for the item may deter some customers from completing the purchase. The requirement for a service point in the shop generally increases the length of time required to purchase the item and also increases the operating costs for the shop.

It will be appreciated that a shop operating a card system may also sell goods in the usual manner whereby goods are displayed on shelves and paid for at the checkout. Such a dual way of selling goods may necessitate that the service point is required to operate as a secondary payment point to reduce operating costs of the shop. The secondary payment point may also stock and sell restricted items such as cigarettes which means that customers trying to exchange a card for an item may have to queue twice within the store. This may further deter a customer from purchasing an item.

It is further known to provide a theft-resistant container for selling a high value product. The product is enclosed in the container which is generally tamper resistant and securely sealed to inhibit opening by the customer. The container may have a transducer or other tag that is detectable by an anti-shoplifting sensor system in a shop. To purchase the product the customer selects a container from the display shelf and takes it to the checkout where it is opened and the product removed. These containers have the disadvantage that the product can still be stolen from the shop. Furthermore each checkout must have a tool or apparatus for opening the containers. The tool or apparatus increases the operating costs of the shop and the requirement to open the containers wastes time in completing the purchase.

It is also known to display a product in a locked cabinet behind a sales counter in a shop. This arrangement requires a sales assistant to serve the customer, which has the disadvantage that the customer may have to wait for the assistant to attend them, or be reluctant to call for assistance. The requirement for a sales assistant generally adds to the operational costs on the shop, and may reduce planned or impulse sales as it prevents the customer's ability to interact with the product.

A further way of selling goods is to display them in an in-store catalogue, which the customer browses before making their selection and paying for the item. After paying the customer proceeds to a service point to collect the item. The catalogue may also reduce both planned and impulse sales as it prevents the customer's ability to interact with the product or gauge its actual size and appearance.

It is yet further known to sell medicines at a pharmacy or a grocery store. In the UK, and other countries, some in Europe, medication to treat common, minor ailments falls into three categories under Government legislation. These categories are prescription-only medicines, general sales list medicines and pharmacy medicines. General sales list medicines such as remedies to treat cold/flu, indigestion and headaches, are typically displayed on the retail sales floor. However, the sale of pharmacy medicines such as remedies for colds/allergies/sinus, asthma, chronic migraine, pain management, gastrointestinal conditions, skin conditions, heart disease prevention and eye infection must be supervised by a pharmacist. The customer must first speak to the pharmacist who then makes or supervises the sale from securely stored medicines behind the counter. Locating pharmacy products behind the counter aims to ensure that customers benefit from the advice and care of a pharmacist, and also satisfies the legal requirement that a pharmacist must make or supervise the sale.

In the US and a number of other countries, some European, a similar situation applies but there are only two categories of medicines, namely those available with a prescription and those available without a prescription. Medicines available without a prescription may also include restricted medicines that typically require a pharmacist to make or supervise the sale.

The general public has a tendency to self diagnose and for many common, minor ailments they often first visit the retail sales floor of a pharmacy or grocery store with an in-house pharmacy. This means that many customers tend to make their self-care choices from the products available on the retail sales floor. When customers only shop for products on the retail sales floor, and do not approach the pharmacist directly they may not be aware of possible pharmacy medicine that may be more appropriate to their needs. One solution to this problem is to use signage at the shelf on the retail floor to advise shoppers to ask for pharmacy medicine at the pharmacy counter. Experience has shown that such signage is ineffective, as shoppers tend not to read it, not least because they are looking for products and not for signs to read.

According to a first aspect of the invention there is provided an apparatus for merchandising including:
a point of sale;
a stock of at least one product for sale; and
a display point having at least one package, the package including a replica of the at least one product for sale;
wherein the apparatus is arranged to enable the package to be exchanged for the at least one product.

Such an apparatus has the advantage of making a customer believe that the package contains a real product so that they do not think that the product is out of stock. The customer is not deterred from completing the sale because they believe that the product is in stock which has the effect that sales do not tend to decline. By replica we mean a model or an otherwise realistic copy or facsimile of the product. The replica may be such that it may be mistaken for the real product. Exchanging the replica of the product avoids the requirement for the product to be removed from any package at the point of sale. In this way the length of time required to purchase the product is reduced.

It will be appreciated that even if the customer realises or knows that the package does not contain a real product they may believe that the product is in stock which does not deter them from completing the purchase. This may be the case, for example, if the package has a label which states that the package contains a replica product.

The apparatus also has the advantage of providing enhanced security to the product for sale. If the package is stolen the cost to a shop operating such an apparatus is minimal due to the fact that only a replica product has been taken.

It is further know to merchandise a product by providing empty packages of the product on shelves, such as empty boxes of a premium alcoholic drink, which are subsequently filled with the product at the point of sale. The packaging on display is the packaging that the customer takes home. However, the customer is still deterred from purchasing the product because they notice that the box is too light and perceive that the product is out of stock. A further problem is encountered at the point of sale whereby filling the package with the goods takes time, especially if the package is not easily opened. The package may also be damaged by removing and subsequently replacing the goods which is undesirable.

The present invention differs from this known way of merchandising premium alcoholic drinks because the packaging of the invention contains a replica of the real product, and the customer does not take home the display packaging. The customer is not deterred from purchasing the product and the time wasted in filling the package at the point of sale is eliminated.

The stock of at least one product for sale may be remote from the point of sale such that the product purchased is provided to the point of sale on demand, for example by a delivery system such as a delivery conveyor belt or by a person assigned to the duty of providing product to the point of sale. Alternatively the stock of at least one product can be at a separate counter.

The present invention provides an advantage in the merchandising of medicines because it allows a replica medicine to be displayed on a display shelf on the retail sales floor next to general sales list medicines. Customers tend to shop for products on the retail sales floor according to the symptoms sought to be relieved. The known way of selling medicines that require a pharmacist to supervise the sale does not help customers to make an informed choice from all of the products which may be available to treat a particular ailment. The present invention breaks this convention and enables pharmacy medicines to be openly marketed on a display shelf on the retail sales floor next to the general sales list medicines. This provides the customer with a high visibility of the pharmacy medicines whilst preventing unsupervised sales of pharmacy medicines. The customer can select a package including a replica product of the pharmacy medicine, and take it to the pharmacist where it can be exchanged for the pharmacy medicine.

Preferably the apparatus is arranged to enable the package to be exchanged for the at least one product at the point of sale.

Preferably the display point is a display shelf of a shop for stacking or hanging the packages thereon.

Preferably the apparatus is arranged to permit the package to be returned to the display point. This may be performed by a person assigned to the duty of returning packages to the display point or by a return system such as a return conveyor belt.

In one embodiment the apparatus includes a counting device for counting the number of products exchanged for packages at the point of sale. Such a device may assist with controlling the stock and inventory of products in a shop. In this way the customer and a shop manager will know that the stock and inventory control of the shop is accurately managed to ensure supply of a product to the customer.

Preferably the counting device is arranged to count the number of packages returned to the display point.

The apparatus may further be arranged to provide an alarm if either the number of packages at the display point, or the number of products at the point is sale is below a minimum threshold.

Preferable the apparatus includes an ordering device for ordering more product if the number of products at the point is sale is below the minimum threshold. It will be appreciated that the step of counting and ordering can be automated to be performed by a stock management system.

Preferably the package is at least partially transparent so that the replica inside the package is visible. Such visibility of the replica may assist in convincing the customer that the package contains the product.

Preferably the package is weighted to substantially correspond to the mass of the product. Such weighting of the package may further assist in convincing the customer that the package has the correct feel to contain the product. In a preferred embodiment the package is weighted to be within 10% of the mass of the product.

In one embodiment the package has an image such as a holographic image of the product. Such a holographic image may further assist in convincing the customer that the package contains the product, or at least psychologically giving them comfort as to what the real product will actually be like.

Preferably the package is adapted to be tamper resistant. Such a tamper resistant property may inhibit opening of the package should a customer try to damage it, either with or without tools. The tamper resistant package might inhibit opening of the package using reasonable force.

The package may be provided with a security tag such as a radio frequency (RF) tag, electro-magnetic (EM) tag, or acousto-magnetic (AM) tag to act as a deterrent to theft of the package.

The package may be provided with a unique serial identifier, such as a number to allow each package to be individually identified. This may help with, for example, stock control and/or the initiation of the replacement of packages to the shelf and/or product to the point of sale. The unique serial identifier may also act as a deterrent to theft.

The unique serial identifier may be visually represented. Alternatively, the unique serial identifier may be stored electronically on a chip or identification tag, for example, as an electronic product code (EPC) on a radio frequency identification (RFID) device.

Preferably the package is hermetically sealed to inhibit deterioration of the replica. Such deterioration might be caused by, for example, high humidity. The package may contain an inert gas such as nitrogen to further inhibit deterioration of the replica.

Preferably the package is abrasion resistant so that its appearance is substantially maintained after repeated use.

The package may have a flat base so that it can be placed on a surface such as a display shelf. The package may have a hanging means so that it can be displayed by hanging. The hanging means may comprise a hole through the package. The hanging means may further be detachable from the package. Preferably the hole also passes through the replica.

Preferably the package at least partially conforms in shape to the replica within it. The package may be at least partially made of a rigid material or at least partially made of a pliable or otherwise soft material. Such a pliable material allows the replica to be felt through the package. The rigid, and/or pliable or soft material is a plastic material.

According to another aspect of the invention there is provided a shop having an apparatus for merchandising including:
a point of sale;
a stock of at least one product for sale; and
a display point having at least one package, the package including a replica of the at least one product for sale;
wherein the apparatus is arranged to enable the package to be exchanged for the at least one product.

Preferably the apparatus is arranged to enable the package to be exchanged for the at least one product at the point of sale.

According to another aspect of the invention there is provided a package for merchandising a product, the package including a replica of a product to be merchandised.

According to another aspect of the invention there is provided a merchandising kit including:
at least one product for sale;
at least one package, the package including a replica of the at least one product for sale; and
instructions for using the merchandising kit.

Such a kit can be supplied to a shop for use in merchandising of the product.

Preferably the ratio of the number of packages to product in the kit is about 1:4. In a preferred embodiment the ratio is about 1:10.

Alternatively the ratio is 1:1 such that a customer could take all of the packages and be assured that this number of products was available for purchase. In this arrangement replenishment of packages from the point of sale to the display point only takes place when the stock of product at the point of sale or available to the point of sale is replenished. Should the shop be out of stock of the product then no packages are available at the display point. In this arrangement the customer is assured of being able to purchase a product if a package is present at the display point.

Preferably the instructions describe the steps of:
stocking the at least one product at a point of sale;
displaying the at least one package at a display point; and
exchanging the package for the at least one product at the point of sale.

Preferably the instructions describe the step of exchanging the package for the at least on product at the point of sale.

The invention will now be described, by way of example only, with reference to the accompanying drawings, in which:

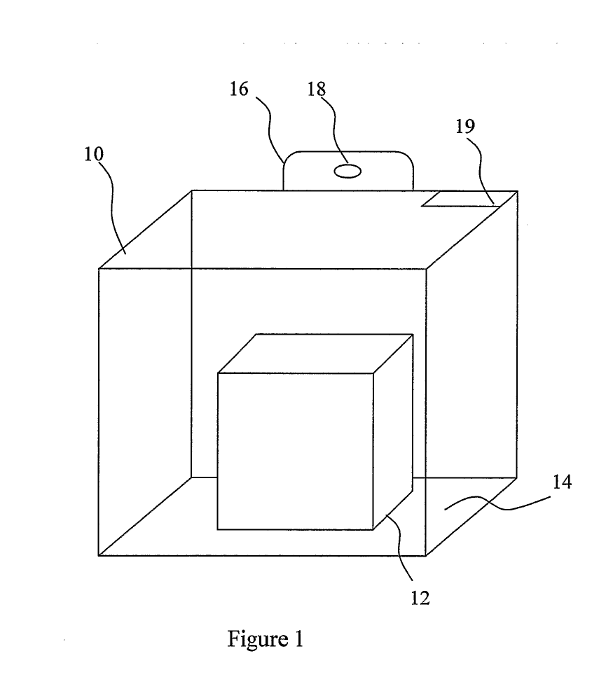

FIG. 1 is a perspective view of a container for use with a merchandising system according to an embodiment of the present invention;

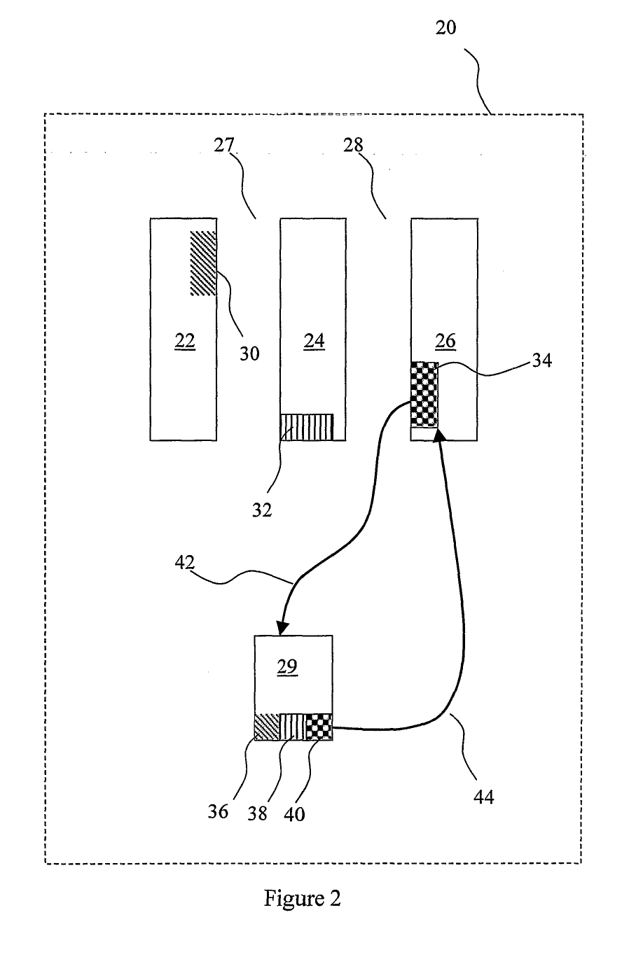

FIG. 2 is a plan view of a shop floor to illustrate how the container of FIG. 1 is used;

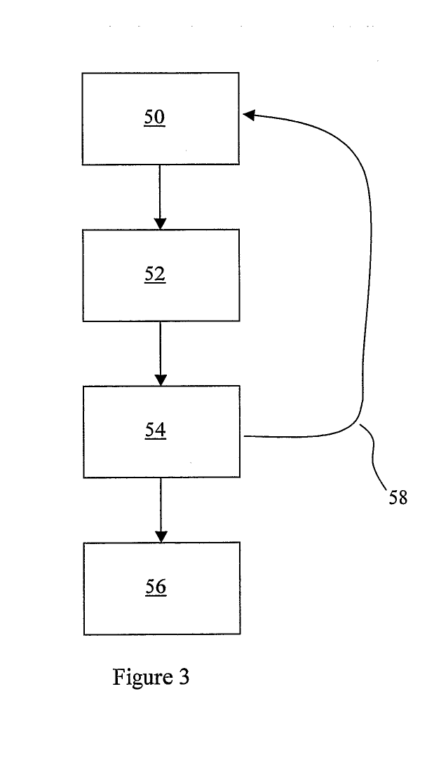

FIG. 3 is a process flow diagram showing steps in the merchandising system;

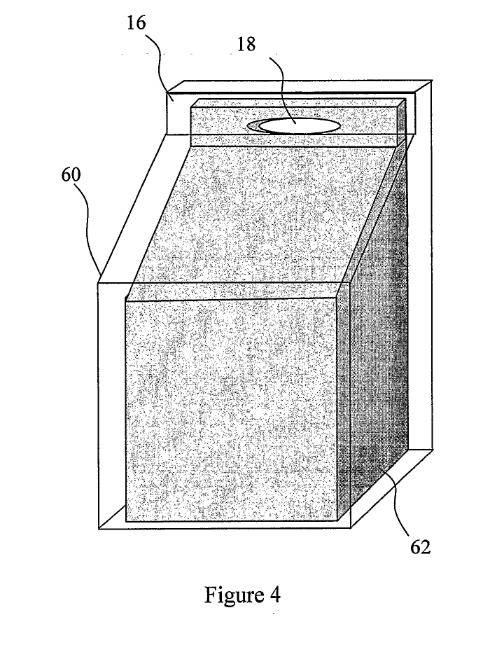

FIG. 4 is a perspective view of an alternative container for use with a merchandising system according to the present invention; and

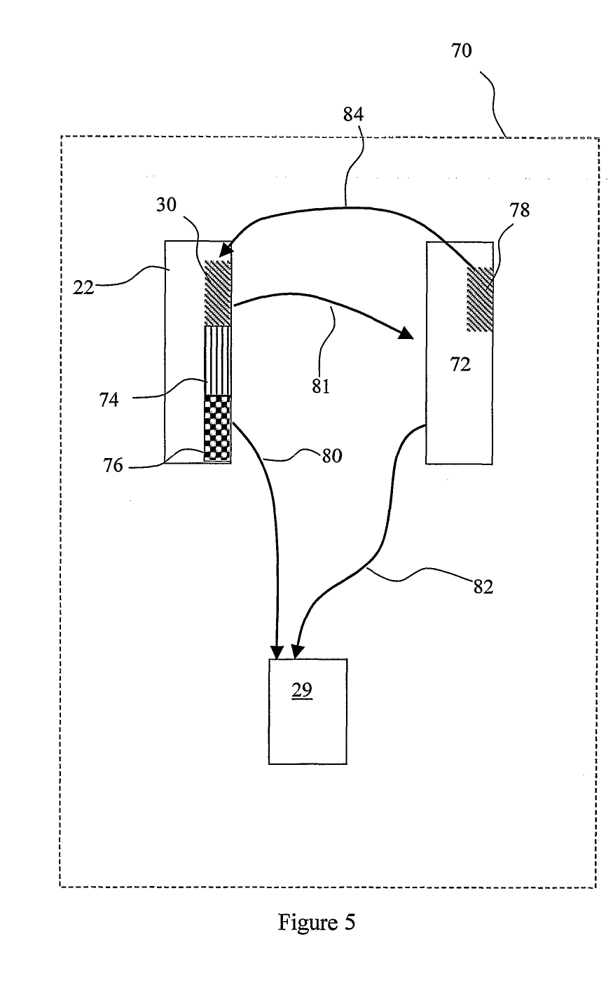

FIG. 5 is a plan view of a shop floor to illustrate how the merchandising system is used for the sale of medicines.

Referring to FIG. 1, there is shown a container 10 for use with a merchandising system according to an embodiment of the present invention. The container 10 is transparent so that a replica product 12 inside the container 10 is visible to a customer. In FIG. 1 the sides, top and bottom of the container 10 are all shown as being transparent. The replica product 12 is sized and weighted to correspond to the visual appearance and mass of a real product so that the customer believes that the container 10 contains a real product. The replica product 12 may be a holographic image or a three dimensional (3D) model of the real product, either of which being weighted to correspond to the mass of a real product. In an alternative embodiment the container 10 is the replica product 12 which avoids the requirement for a separate container 10 and the replica product 12.

The container 10 is adapted to be relatively tamper resistant so that the customer cannot open it using reasonable force. Such a tamper resistant property may be provided by constructing the container 10 from an impact resistant plastic. The tamper resistant property inhibits opening of the container 12 should a person try to damage it either with or without tools. The container 10 is provided with a radio frequency identification (RFID) device 19 to act as a deterrent to theft of the container 10. The container 10 is hermetically sealed so that the replica product does not deteriorate due to contamination such as water ingress. The container is also abrasion resistant so that its appearance does not substantially deteriorate. This enables the container 10 to be used many times before it is required to be replaced.

The container 10 is provided with a flat base 14 so that it can be placed on a display shelf, shown at 22, 24, 26 in FIG. 2. In FIG. 1 the container 10 may have a hanging mechanism 16 having a hole 18 therethrough so that that the container 10 can be hung on a display hook (not shown) of a display shelf 22, 24, 26.

FIG. 2 is a plan view of a shop floor 20 to illustrate how the container 10 of FIG. 1 is used. In FIG. 2 the shop floor 20 is shown with three display shelves 22, 24, 26 having two aisles 27, 28 between them. The shop floor 20 also has a checkout 29. For illustrative purposes each shelf 22, 24, 26 is shown with respective containers having three different replica products 30, 32, 34. A customer can walk round the shelves 22, 24, 26 on the shop floor 20 in the conventional manner and look at the replica products 30, 32, 34 on the shelves 22, 24, 26. The checkout 29 has a stock of real products 36, 38, 40 that correspond to the replica products 30, 32, 34. The stock of products 36, 38, 40 is not on display to customers, and is in a secure, accessible place to the person operating the checkout.

In the example of FIG. 2 a customer selects a container 10 having a replica product 34 from the display shelf 26 and carries it to the checkout 29 illustrated by the arrow 42. The customer then pays for the replica product 34 where it is exchanged by a checkout attendant for a real product 40 that corresponds to the replica product 34. The customer can then exit the shop floor 20 having made their purchase. The replica product 34 which was exchanged at the checkout 29 is then returned to the display shelf 26 illustrated by arrow 44. The replica products 30, 32, 34 that are exchanged at the checkout 29 can be loaded onto a storage trolley (not shown) at the checkout 29 to make the process of returning them back to the display shelf 26 easier. In an alternative embodiment the stock of products 36, 38, 40 is not at the checkout 29 but is remote from the checkout 29. In this arrangement the product 36, 38, 40 purchased at the checkout 29 can be individually provided to the checkout 29 on demand, for example by a member of staff or a delivery system such as a conveyor belt. Alternatively the stock of products 36, 38, 40 can be at a separate counter either before or after the checkout 29.

FIG. 3 shows a process flow diagram to illustrate steps in the above described merchandising system. Box 50 represents the step of stacking of the replica products 30, 32, 34 onto the display shelves 22, 24, 26.

Box 52 represents the step of a customer selecting a container 10 having one of the replica products 30, 32, 34 and taking it to the checkout 29. Box 54 represents the step where the customer exchanges the replica product 30, 32, 34 for a corresponding real product 36, 38, 40 and pays for the real product. The customer can then exit the shop which is indicated by box 56. An arrow 58 from the box 54 to the box 50 represents the step of returning the replica product 30, 32, 34 to the display shelf 22, 24, 26.

FIG. 4 shows a perspective view of an alternative container 60 for use with a merchandising system according to the present invention. Like features to the embodiment of FIG. 1 are shown with like reference numerals. In FIG. 4 the container 60 is shown with a shape topologically similar to a replica product 62 contained within it. In this arrangement the container 60 conforms to the replica product 62 either in a similar way or substantially identically so that contours of the container 60 follow the contours of the replica product 62. Alternatively the container 60 conforms only partially so that only certain parts of the container 60 conform to the replica product 62. The advantage of such an arrangement is that a customer handling the container 60 is able to more fully appreciate and obtain a better idea of the replica product 62 contained within it. In another arrangement the container 60 may be made of a pliable plastic material and/or a transparent material so that the customer can touch and feel the replica product 62 through the container 60. Such a container 60 may further assist in persuading the customer to purchase the product corresponding to the replica product 62.

FIG. 4 also shows a hanging mechanism 16 having a hole 18 therethrough so that the container 60 can be hung on a display hook (not shown) of a display shelf 22, 24, 26. The hole 18 also passes through the replica product 62 so that the display hook can pass through the replica product 62 and the container 60. Such an arrangement has the advantage that the display hook can carry the weight of the replica product directly, and not indirectly via the container 60. This arrangement helps with providing a robust container 60 that can be reused many times.

FIG. 5 is a plan view of a shop floor to illustrate how the merchandising system is used for the sale of medicines. Like features to the embodiment of FIG. 2 are shown with like reference numerals. In FIG. 5 a shop floor 70 is shown with one display shelf 22 for the purposes of clarity, but it will be appreciated that there may be many display shelves in practice. The shop floor 70 also has a checkout 29 which is operated by an attendant, and a pharmacy counter 72 which is operated by a pharmacist. The shelf 22 is shown with containers having a replica product 30 which corresponds to a medicine that must be sold under the supervision of a pharmacist. The shelf 22 is also shown with real medicines or products 74, 76 that are not required to be sold under the supervision of a pharmacist. The pharmacy counter 72 has a stock of a real product 78 that correspond to the replica product 30. The stock of real product 78 is in a secure, accessible place to the pharmacist at the pharmacy counter 72.

In the example of FIG. 5 a customer can walk round the shelf 22 on the shop floor 70 in the conventional manner, and look at the replica product 30 and the real products 74, 76 on the shelf 22. To purchase a medicine or product 74, 76 that is not required to be sold under the supervision of a pharmacist the customer takes the medicine or product 74, 76 from the shelf 22 to the checkout 29 illustrated by the arrow 80. The customer can then exit the shop floor 70 having made their purchase. To purchase a medicine or product 78 that is required to be sold under the supervision of a pharmacist the customer takes replica product 30 from the shelf 22 and to the pharmacy counter 72 illustrated by the arrow 81. The replica product 30 is then exchanged for a real product 78 under the supervision of a pharmacist. The customer then takes the real product 78 to the checkout 29 illustrated by the arrow 82 to pay for it. The customer can then exit the shop floor 70 having made their purchase. Alternatively the sale of the real product 78 can take place at the pharmacy counter 72.

The replica product 30 that was exchanged at the pharmacy counter 72 is then returned to the display shelf 22 illustrated by arrow 84. Locating the real product 78 at the pharmacy counter 72 ensures that customers benefit from the advice and care of a pharmacist, and also satisfies the legal requirement that a pharmacist must make or supervise the sale. This system also provides the customer with a high degree of visibility of restricted medicines so that they can make a more informed choice about medicine that might be appropriate to their needs.

It will be appreciated that the above described apparatus and merchandising system could be used as a way of controlling the stock and inventory of goods in a shop. Each time a real product 36, 38, 40 is paid for at the checkout 29 a manual or an automated system for stock and inventory control can be updated. In one embodiment the automated system keeps a record of the number of replica products 30, 32, 34 on the display shelves 22, 24, 26 and will provide an alarm to a member of the shop staff such as a manager of the shop, or to an external agency, for example an outsourced firm, if the number of replica products 30, 32, 34 on one or more of the display shelves 22, 24, 26 becomes too low. In another embodiment the automated system keeps a record of the number of real products 36, 38, 40 at the checkout 29 and will provide an alarm to the manager if the number of real products 36, 38, 40 becomes too low. The automated system may also be arranged to order more real products 36, 38, 40 if the stock at the checkout becomes too low. In this way the customer and the shop manager will always know that the stock and inventory control of the shop and display shelves 22, 24, 26 is accurately controlled. To assist with this each replica product 30, 32, 34 is provided with a unique serial number to allow each package to be individually identified. The unique serial number may be a visually represented number, for example as a one-dimensional barcode or a two dimensional barcode.

Customers who purchase goods which are sold using the above described apparatus and merchandising system may believe that the item that they select from the display shelf 22, 24, 26 is a real product. This has the advantage that they are less likely to think that the item is out of stock, and hence more likely to complete the purchase by walking to the checkout 29 with the replica product 30, 32, 34 and paying for the item.

The above described apparatus and merchandising system also has the advantage of providing an additional level of security to the goods being sold and may be particularly useful for the sale of high value items such as perfumes, jewellery, electric goods, hardware tools, razors, razor blades, health and beauty products or aids, mobile phones, computers, computer accessories or premium alcoholic drink. If the replica product 30, 32, 34 is stolen from the shop there is minimal loss of revenue. A further advantage of the above described apparatus and merchandising system is that there is less need for security personnel or surveillance equipment in the shop due to the increased security provided by the replica products 30, 32, 34. This results in a further advantage that a shop operating such a system of merchandising has reduced operating costs which provides a consequent increase in operating profits for the shop.

The above described apparatus and merchandising system further has the advantage of providing an alternative way of selling medicines that require a pharmacist to sell the medicine or supervise the sale. The present invention allows a replica medicine to be displayed on a display shelf on the retail sales floor next to general sales list medicines which are not required to be sold under the supervision of a pharmacist. This provides the customer with a high visibility of the restricted medicines whilst preventing unsupervised sales of restricted medicines.

The above described apparatus and merchandising system further has the advantage of providing an alternative way of selling medicines that are required to be kept behind a counter, where customers do not have direct access before the sale is made. The present invention allows a replica medicine to be displayed on a display shelf on the retail sales floor next to non-prescription medicines which customers can have direct access to. This provides the customer with a high visibility of the restricted medicines whilst preventing unsupervised sales of restricted medicines.

It will be appreciated that any of the features of any of the embodiments of the invention, may also be used with other embodiments of the invention.

1. An apparatus for merchandising including:
a point of sale;
a stock of at least one product for sale; and
a display point having at least one package, the package including a replica of the at least one product for sale;
wherein the apparatus is arranged to enable the package to be exchanged for the at least one product.

2. An apparatus according to claim 1 wherein the apparatus is arranged to enable the package to be exchanged for the at least one product at the point of sale.

3. An apparatus according to claim 1 wherein the display point is a display shelf of a shop for stacking or hanging the packages thereon.

4. (canceled)

5. An apparatus according to claim 1 and further including a counting device for counting the number of packages returned to a display point.

6. An apparatus according to claim 1 wherein the apparatus includes a counting device for counting the number of products exchanged for packages at the point of sale.

7. An apparatus according to claim 5 and further arranged to provide an alarm if either the number of packages at the display point, or the number of products at the point of sale is below a minimum threshold.

8. (canceled)

9. An apparatus according to claim 1 wherein the package is at least partially transparent so that the replica inside the package is visible.

10-15. (canceled)

16. An apparatus according to claim 1 wherein the package is provided with a unique serial identifier.

17-22. (canceled)

23. An apparatus according to claim 1 wherein the package at least partially conforms in shape to the replica within it.

24-29. (canceled)

30. A package for merchandising a product, the package including a replica of a product to be merchandised.

31. A package according to claim 30, the package being at least partially transparent so that the replica inside the package is visible.

32. A package according to claim 30 wherein the package is weighted to substantially correspond to the mass of the product.

33. (canceled)

34. A package according to claim 30 and further including a holographic image of the product.

35. A package according to claim 30 and further adapted to be tamper resistant.

36-37. (canceled)

38. A package according to claim 30 and further provided with a unique serial identifier.

39-40. (canceled)

41. A package according to claim 30 wherein the package is hermetically sealed to inhibit deterioration of the replica.

42. A package according to claim 41 wherein the package contains an inert gas to further inhibit deterioration of the replica.

43-44. (canceled)

45. A package according to claim 30 which at least partially conforms in shape to the replica within it.

46-50. (canceled)

51. A merchandising kit including:
at least one product for sale;
at least one package, the package including a replica of the at least one product for sale; and
instructions for using the merchandising kit.

52. A merchandising kit according to claim 51 wherein the instructions describe the steps of:
stocking the at least one product at a point of sale;
displaying the at least one package at a display point; and
exchanging the package for the at least one product.

53-56. (canceled)
